(19) United States
(12) Patent Application Publication
(10) Pub. No.: US 2017/0166422 A1
(43) Pub. Date: Jun. 15, 2017

(54) TRANSLATING BODY RESCUE HOIST

(71) Applicant: Goodrich Corporation, Charlotte, NC (US)

(72) Inventor: Steven D. Mahnken, Long Beach, CA (US)

(21) Appl. No.: 14/967,661

(22) Filed: Dec. 14, 2015

(51) Int. Cl. B66D 1/12; B66D 1/38; A62B 35/00; B66D 1/22

(52) U.S. Cl. CPC B66D 1/12; B66D 1/22; B66D 1/38; A62B 35/00

(57) ABSTRACT

A translating body rescue hoist includes a fixed frame and a carrier supported by the fixed frame. The carrier rides on bearings such that the carrier is capable of reciprocating relative to the fixed frame. The carrier supports a cable drum and a level wind mechanism. A drivetrain is mounted within the cable drum and driven by a motor mounted to the carrier. The drivetrain drives the cable drum, and the level wind mechanism is driven off the cable drum. As the cable drum rotates, a cable is fed off of the drum and through a fixed payout point. A follower is fixed to the frame and interlocked with the level wind mechanism such that rotating the level wind mechanism drives the carriage in a reciprocating manner. The level wind mechanism is self-reversing allowing the stationary frame to reciprocate while the level wind mechanism is rotated in a single direction.

### BACKGROUND

The present disclosure relates generally to hoists. More particularly, this disclosure relates to a translating body rescue hoist for an aircraft.

Rescue hoists deploy and retrieve a cable from a cable drum to hoist persons or cargo. Rescue hoists may be mounted to aircraft, such as helicopters, and utilized to hoist the person or cargo to safety. The rescue hoist includes a cable drum off of which the cable is deployed. The cable is deployed through a cable guide, and the rescue hoist also contains a mechanism for level winding the cable across a length of the cable drum. The cable must be levelly wound onto the cable drum to prevent fouling of the cable and to prevent the cable from experiencing extra strain. The portion of the cable outside of the rescue hoist may experience side loads due to the rotation or swaying of the load being hoisted, and the side loads are transmitted to the rescue hoist.

Rescue hoists typically have two configurations. A category one hoist includes a translating drum, where the translating drum functions as the level winding mechanism. The category one hoist allows for the cable to be deployed through a single point in the hoist housing, thereby dispersing side loads from the cable to the structure of the hoist. Category one hoists use very precise, high-quality spur drivetrains and the drivetrain is mounted separate from the translating drum. A category two hoist includes a stationary drum and the drivetrain is mounted within the drum, which provides for a compact footprint of the hoist. The category two hoists include a translating level wind mechanism that shuttles in a reciprocating manner to level wind the cable onto the drum. The translating level wind is susceptible to fouling due to side loads experienced by the cable, as the side loads are transferred through the level wind mechanism to structure.

### SUMMARY

According to an embodiment of the present disclosure, a hoist system includes a stationary frame, a cable guide array mounted to the stationary frame, a follower mounted to the stationary frame, a carrier housed within the stationary frame, the carrier mounted on bearings, a cable drum mounted on the carrier, a level wind mechanism mounted on the carrier outward of the cable drum, a drivetrain mounted within the cable drum, the drivetrain configured to drive the cable drum and the level wind mechanism, and a motor mounted on the carrier, the motor coupled to the drivetrain. A cable is wrapped around the cable drum and fed through the cable guide array, and the carrier is capable of reciprocating relative to the stationary frame.

According to another embodiment of the present disclosure, a method of hoisting includes feeding a cable around a cable drum and through a cable guide array, the cable guide array fixed to the stationary frame, engaging a follower with a level wind mechanism, and driving a cable drum and the level wind mechanism with a drive system at least partially mounted within the cable drum. The follower is interlocked with the level wind mechanism such that rotating the level wind mechanism drives a carriage in a reciprocating manner relative to the stationary frame.

According to yet another embodiment of the present disclosure, a rescue hoist includes a stationary module fixed to a vehicle, a translating module, and a cable. The stationary module includes a frame, a cable guide array mounted to the frame, a follower mounted to the frame, and a traction sheave mounted to the frame. The translating module includes a carrier supported by the frame, the carrier configured to oscillate relative to the frame, a cable drum rotatably mounted to the carrier, a drive mounted to the carrier and at least partially disposed within the cable drum, and a level wind mechanism mounted to the carrier and intermeshed with the follower. The cable is disposed about the cable drum and extends through the traction sheave and the cable guide array. The translating module is configured to oscillate relative to the frame to unspool the cable from the cable drum or spool the cable on to the cable drum.

### BRIEF DESCRIPTION OF THE DRAWINGS

FIG. 1 is a schematic of a translating body rescue hoist system.

FIG. 2A is a front perspective view of a translating body rescue hoist.

FIG. 2B is a rear perspective view of a translating body rescue hoist.

FIG. 3 is a bottom plan view of a translating body rescue hoist.

FIG. 4 is a schematic view of a powertrain for a translating body rescue hoist.

FIG. 5 is a cross-sectional view of a heat exchanger system for a translating body rescue hoist.

### DETAILED DESCRIPTION

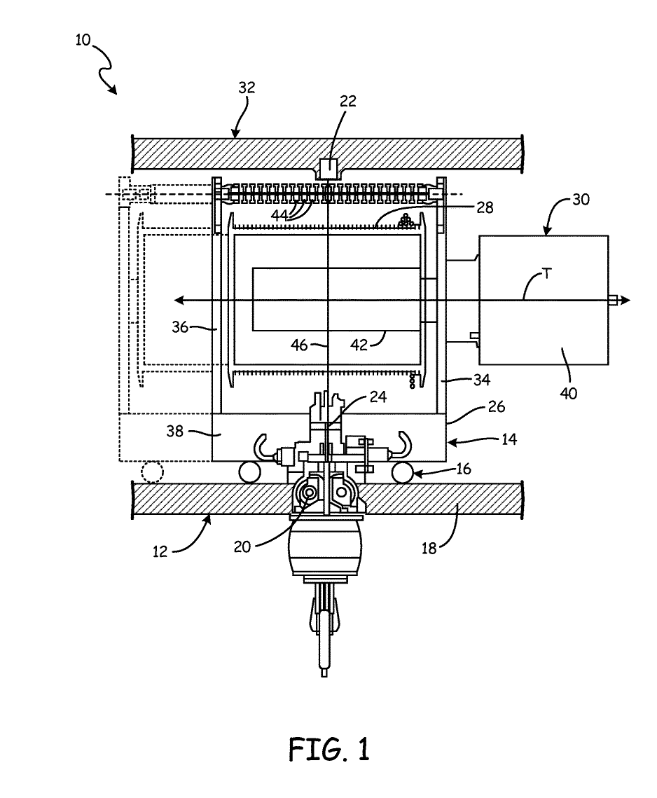

FIG. 1 is a schematic view of translating body rescue hoist 10. Translating body rescue hoist 10 includes stationary module 12 and translating module 14, and bearing assembly 16. Stationary module 12 includes frame 18, cable guide array 20, follower 22, and traction sheave 24. Translating module 14 includes carriage 26, cable drum 28, drive 30, and level wind 32. Carriage 26 includes first end 34, second end 36, and body 38. Drive 30 includes motor 40 and drivetrain 42. Level wind 32 includes grooves 44.

Carriage 26 is supported by bearing assembly 16, which is mounted to frame 18. Bearing assembly 16 supports carriage 26 such that carriage 26 may oscillate relative to frame 14, as indicated by arrow T. Cable drum 28 is rotatably mounted on carriage 26 and is supported between first end 34 and second end 36. Drive 30 is mounted to carriage 26 with motor 40 directly mounted to one of first end 34 or second end 36. Drivetrain 42 is attached to and driven by motor 40. Drivetrain 42 further extends into cable drum 28. Level wind 32 is rotatably mounted to carriage 26 and supported by first end 34 and second end 36. Level wind 32 is driven by an auxiliary drive taken from an end of cable drum 28.

Cable guide array 20 is mounted to frame 18. Traction sheave 24 is mounted to frame 18 between cable guide array 20 and follower 22. Follower 22 is similarly mounted to frame 18, and follower 22 is mounted proximate to and engaged with level wind 32. Follower 22 includes a mechanism, such as a follower blade, that meshes with grooves 44 of level wind 32. Cable 46 is wound about cable drum 28, and cable 46 extends through traction sheave 24 and exits translating body rescue hoist 10 through cable guide array 20.

To either deploy or retrieve cable 46 from translating body rescue hoist 10, motor 40 is initiated, and motor 40 drives drivetrain 42. Drivetrain 42 engages with cable drum 28 and causes both cable drum 28 and level wind 32 to rotate. As cable drum 28 rotates, cable 46 is unspooled and proceeds through traction sheave 24 and cable guide array 20. Traction sheave 24 is a back-tension device configured to maintain a desired tension on cable 46 inboard of traction sheave 24 and onto cable drum 28. In this way, traction sheave 24 ensures discrete winding of cable 46 and prevents tangling of cable 46 within translating body rescue hoist 10. Follower 22 is intermeshed with grooves 44 located on level wind 32. As level wind 32 rotates follower 22 maintains a connection with grooves 44 on level wind 32 and tracks along grooves 44. Due to the fixed connection of follower 22 and frame 18, follower 22 remains in a fixed position while level wind 32 rotates causing level wind 32 to shift axially as the follower blade tracks along grooves 44. Level wind 32 thereby drives translating module 14 axially, as shown by the dashed lines. Level wind 32 is preferably a self-reversing screw, and as such, follower 22 tracks level wind 32 in a first direction until follower 22 reaches an end of level wind 32, then follower 22 reverses direction and tracks level wind 32 in a second direction, opposite the first direction, while level wind 32 continues to rotate in the first direction. As such, translating module 14 is driven in a reciprocating manner while level wind 32 rotates in a single direction. Carriage 26 rides on bearing assembly 16 and bearing assembly 16 allows carriage 26 to smoothly reciprocate relative to frame 18.

Level wind 32 may be retained axially with springs, such as disc springs, that provide vibration damping between translating module 14 and stationary module 12. Level wind 32 may be any suitable device for engaging with follower 22 and driving translating module 14 in a reciprocating manner. For example, level wind 32 may be a reversing screw, which is grooved such that the screw may rotate in a single direction but the following mechanism, such as follower 22, reverses a direction of travel by following along the grooves. As such, level wind 32 may rotate in a single direction to drive translating module 14 in a reciprocating manner.

As translating module 14 reciprocates, cable 46 is either wound onto or off of cable drum 28, depending on the direction of rotation of cable drum 28. As cable drum 28 rotates, cable drum 28 also moves axially as translating module 14 moves in a reciprocating manner. Cable drum 28 moving axially provides level winding of cable 46 on to cable drum 28. Level wind 32 prevents cable 46 from piling at one end of cable drum 28 because level wind 32 reverses the direction of travel of cable drum 28 when cable 46 has reached an end of cable drum 28. Cable drum 28 may include ridging to guide cable 46 as cable 46 winds onto cable drum 28.

Cable 46 proceeds through traction sheave 24 and cable guide array 20, each of which are fixed to frame 18. Cable 46 exits translating body rescue hoist 10 through cable guide array 20. Cable guide array 20 provides a single point payout for cable 46, such that cable 46 exits and enters translating body rescue hoist 10 at a single, stationary point. The single point payout does not oscillate as cable 46 is being spooled or unspooled; instead, translating module 14 oscillates to wind cable 46. When a load is secured to cable 46, cable 46 may experience side loads due to the rotation or shifting of the load. The single point payout allows for the side loads to be transmitted to frame 18 through the various structural elements that cable 46 passes through, instead of to moving elements of translating body rescue hoist 10. Thus, side loads may be transmitted to frame 18 through cable guide array 20, and on to a vehicle, such as a helicopter, supporting translating body rescue hoist 10 through frame 18.

Cable guide array 20 is fixed to frame 18 thereby allowing side loads to be transmitted directly to frame 18, which reduces the need for additional structure to accommodate the side loads. Follower 22 is also fixed to frame 18, which reduces the need for additional structural elements previously necessary to prevent fouling of the level wind mechanism or the follower itself. Transmitting side loads directly to frame 18 through fixed elements, such as cable guide array 20, increases the efficiency of translating body rescue hoist 10 and reduces the weight of translating body rescue hoist 10 by eliminating additional structural elements. Drivetrain 42 is housed within cable drum 28, and motor 40 is mounted to carriage 26. Mounting drivetrain 42 within cable drum 28 provides a compact mounting arrangement that reduces the overall size of translating body rescue hoist 10.

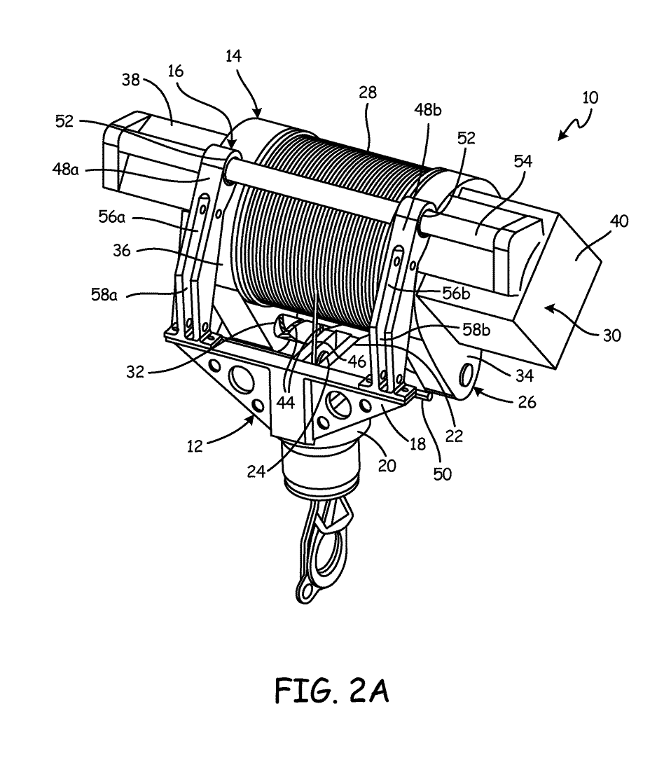

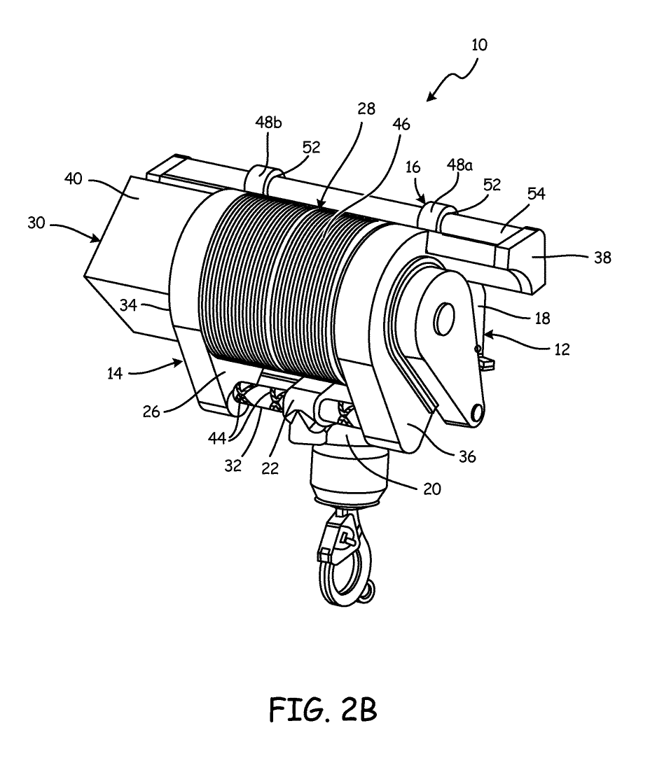

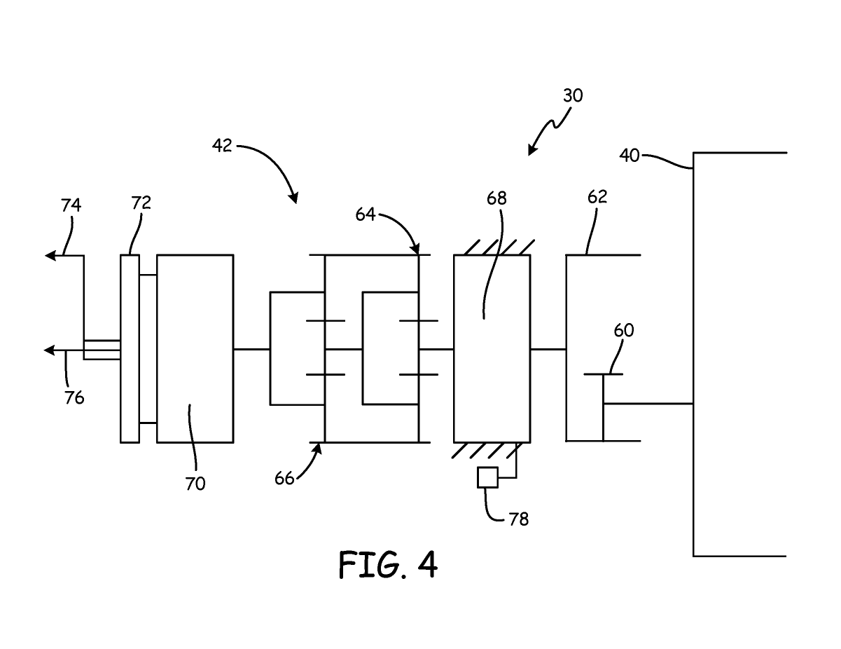

FIG. 2A is a front perspective view of translating body rescue hoist 10. FIG. 2B is a rear perspective view of translating body rescue hoist 10. FIGS. 2A and 2B will be discussed together. Translating body rescue hoist 10 includes stationary module 12, translating module 14, and bearing assembly 16. Stationary module 12 includes frame 18, cable guide array 20, follower 22, and traction sheave 24. Frame 18 includes arms 48a and 48b. Translating module 14 includes carriage 26, cable drum 28, drive 30, and level wind 32. Carriage 26 includes first end 34, second end 36, body 38, and traction shaft 50. Drive 30 includes motor 40 and drivetrain 42 (shown in FIGS. 1 and 4). Level wind 32 includes grooves 44. Bearing assembly 16 includes linear bearings 52 and guide rail 54. Arm 48a includes upper clevis 56a and lower clevis 58a. Arm 48b similarly includes upper clevis 56b and lower clevis 58b.

In the illustrated embodiment, carriage 26 is supported by frame 18. Body 38 of carriage 26 extends between and connects first end 34 and second end 36. Guide rail 54 extends along a length of body 38 and is supported by body 38. Drivetrain 42 extends into and is housed within cable drum 28. Motor 40 is mounted to first end 34 of carriage 26, and motor 40 is connected to and powers drivetrain 42. Cable drum 28 is rotatably mounted on carriage 26 and cable drum 28 is supported between first end 34 and second end 36. Level wind 32 is also rotatably mounted between first end 34 and second end 36. Cable drum 28 is rotatably driven by drivetrain 42, and level wind 32 is preferably rotatably driven by an auxiliary drive from an end of cable drum 28. Traction shaft 50 extends through traction sheave 26, and traction shaft 50 translates through traction sheave 26 as translating module 14 oscillates relative to stationary module 12. Traction shaft 50 drives traction sheave 26 to maintain a back tension on cable 46.

Cable guide array 20 is mounted to frame 18. Follower 22 is similarly mounted to frame 18, and follower 22 is engaged with level wind 32. Follower 22 tracks along grooves 44 of level wind 32. Arms 48a, 48b extend from frame 18, and linear bearings 52 are mounted to the distal ends of arms 48. Guide rail 54 extends through and is supported by linear bearings 52. While linear bearings 52 are illustrated as mounted to the ends of arms 48a, 48b, linear bearings 52 may be mounted at any suitable position on frame 18 to allow translating module 14 to reciprocate on frame 18. Linear bearings 52 may alternatively be mounted to carriage 26 and guide rail 54 may be mounted to frame 18, which arrangement also allows translating module 14 to reciprocate relative to stationary module 12.

Frame 18 is configured to mount directly to an aircraft, such as a helicopter. Translating body hoist 10 may be mounted to the aircraft utilizing a horn mounting configuration or a four point closed mounting configuration. For example, upper clevis 56a, lower clevis 58a, upper clevis 56b, and lower clevis 58, may receive four lugs extending from the aircraft to secure translating body hoist 10 to the aircraft.

Cable 46 is wound about cable drum 28 and extends through follower 22 and cable guide array 20. During operation, cable drum 28 and level wind 32 are simultaneously driven by drive 30. As level wind 32 rotates, the follower blade tracks along grooves 44 of level wind 32 and level wind 32 drives carriage 26 in a reciprocating manner due to the connection of follower 22 and level wind 32. Follower 22 is fixed to frame 18, so the rotation of level wind 32 causes level wind 32 to move axially as the follower blade tracks along grooves 44, while follower 22 remains fixed. Drivetrain 42 is disposed within cable drum 28 and is connected to and driven by motor 40. Motor 40 is mounted to first end 34 of carriage 26. Mounting drivetrain 42 within cable drum 28 reduces the overall width of translating body rescue hoist 10. The compact footprint provided by mounting drivetrain 42 within cable drum 28 allows for the use of longer cable drums thereby reducing the number of cable layers that are wrapped around the cable drum. Longer cable drums and less cable layers reduces cable strain and allows for a more even winding as the cable 46 is deployed.

Guide rail 54 is received by linear bearings 52, which are shown mounted to arms 48a, 48b of frame 18. As level wind 32 rotates, thereby driving translating module 14 in a reciprocating manner, guide rail 54 translates through linear bearings 52, and cable drum 28 shifts axially with regard to cable guide array 20. While linear bearings 52 are shown as mounted to arms 48a, 48b, linear bearings 52 may be mounted to translating module 14. With linear bearings 52 mounted to translating module 14, guide rail 54 is mounted to stationary module 12, and preferably to frame 18, such that translating module 14 may oscillate relative to stationary module 12.

Carriage 26 reciprocates to maintain the alignment of cable 46 with cable guide array 20 and follower 22, thereby ensuring the cable 46 is level wound onto cable drum 28. Cable guide array 20 and follower 22 are mounted directly to frame 18. The portion of cable 46 outboard of cable guide array 20 may transmit side loads to translating body rescue hoist 10 due to a load on cable 46 shifting during hoisting. As cable guide array 20 is mounted directly to frame 18, any side loads experienced by cable 46 are transmitted directly to frame 18 through cable guide array 20. The side loads are then transmitted directly to the aircraft due to the connection of frame 18 to the aircraft. Transmitting side loads directly to frame 18 eliminates additional structural elements previously necessary to handle the side loads. Eliminating additional structural elements reduces the weight of translating body rescue hoist 10 and reduces the cost of translating body rescue hoist 10; in addition, eliminating additional structural elements reduces the complexity of translating body rescue hoist 10.

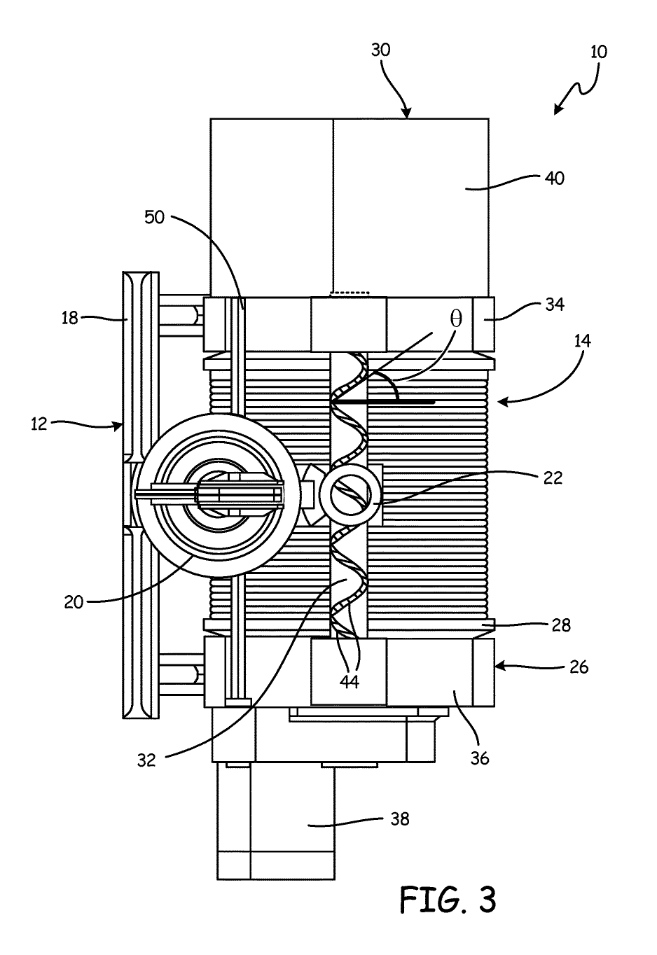

FIG. 3 is a bottom plan view of translating body rescue hoist 10. Translating body rescue hoist 10 includes stationary module 12 and translating module 14. Stationary module 12 includes frame 18, cable guide array 20, and follower 22. Translating module 14 includes carriage 26, cable drum 28, drive 30, level wind 32, and traction shaft 50. Carriage 26 includes first end 34, second end 36, and body 38. Drive 30 includes motor 40 and drivetrain 42 (shown in FIG. 1). Level wind 32 includes grooves 44.

Carriage 26 is supported by frame 18. Cable drum 28 extends between and is rotatably supported by first end 34 and second end 36. Level wind 32 similarly extends between and is rotatably supported by first end 34 and second end 36. Motor 40 is mounted to first end 34, and motor 40 provides power to drivetrain 42 which is mounted within cable drum 28. Follower 22 is integral with frame 18 and follower 22 engages with level wind 32. Follower 22 includes a mechanism, such as a follower blade, that engages with and tracks along grooves 44 of level wind 32. Cable drum 28 is rotatably driven by drive 30 and level wind 32 is driven by an auxiliary drive off of cable drum 28, which auxiliary drive is also driven by drive 30. Traction shaft 50 extends through traction sheave 24 (shown in FIGS. 1, 2A, 2B) and traction shaft 50 is rotatable to drive traction sheave 24 to maintain a back tension on cable 46.

Translating module 14 is driven in a reciprocating manner by the rotation of level wind 32 and the connection of level wind 32 and follower 22. As level wind 32 rotates, level wind 32 drives carriage 26 in a reciprocating manner due to the connection of follower 22 and level wind 32. The follower blade of follower 22 tracks along grooves of level wind 32. As follower 22 is fixed to frame 18, the rotation of level wind 32 causes level wind 32 to shift axially as the follower blade tracks along the grooves 44. As level wind 32 moves axially, level wind 32 causes translating module 14 to simultaneously shift due to level wind 32 being mounted to carriage 26. Cable drum 28 and level wind 32 are configured to rotate at relative speeds such that cable 46 is vertically aligned through cable guide array 20 as cable 46 is fed off of cable drum 28. Moreover, as the follower blade tracks along grooves 44 of level wind 32, helix angle θ determines the rate of axial displacement of translating module 14 relative to the rate of rotation of level wind 32. For example, level wind 32 is illustrated as having a smaller diameter than cable drum 28, so level wind 32 will rotate at a slower speed than cable drum 28 to ensure that cable drum 28 is displaced axially only so far as is necessary to maintain the alignment of cable 46 through cable guide array 20. The relative speeds of cable drum 28 and level wind 32 are maintained through appropriate gearing as level wind 32 is preferably driven off of an auxiliary drive from cable drum 28. The main driver for the ratio of the rate of revolution of level wind 32 to the rate of axial displacement of translating module 14 is helix angle θ of grooves 44.

Level wind 32 is preferably a reversing screw, which allows follower 22 to track along level wind 32 in both a first direction and a second direction as level wind 32 maintains a single direction of rotation. As such, driving level wind 32 in a single direction of rotation will drive translating module 14 in a reciprocating manner, due to the connection of follower 22 and level wind 32.

As shown, follower 22 extends fully about level wind 32. Having follower 22 fully enclose level wind 32 prevents follower 22 from fouling. Follower 22 includes a follower blade that tracks along grooves 44 of level wind 32. Moreover, vibrations transmitted to level wind 32 from translating module 14 are transmitted directly to frame 18 through the direct connection of follower 22 and frame 18.

While cable 46 is shown as passing through follower 22, follower 22 may be mounted to frame 18 such that cable 46 does not pass through follower 22 inboard of cable guide array 20. Follower 22 may be mounted at any suitable location for maintaining a connection with level wind 32 to allow translating module 14 to oscillate relative to stationary module 12. Where cable 46 does not pass through follower 22, follower 22 extends from frame 18 and still engages level wind 32 such that level wind 32 drives translating module 14 in a reciprocating manner. The side loads are thus transmitted directly to frame 18 through cable guide array 20, while vibrations experienced by translating module 14 are transmitted to frame 18 through level wind 32.

FIG. 4 is a schematic view of drive 30 showing the connection of motor 40 and drivetrain 42. Motor 40 includes output gear 60. Drivetrain 42 includes first stage 62, second stage 64, third stage 66, load brake 68, overload clutch 70, traction clutch 72, first output 74, and second output 76. Lube pump 78 is disposed within a sump and is driven off of load brake 68.

Drivetrain 42 is disposed within cable drum 28 (shown in FIG. 1) and provides rotational power from motor 40 to cable drum 28. Output gear 60 is preferably a spur pinion that meshes with first stage 62. Output gear 60 is shown as meshing with first stage 62 at a six o'clock position of first stage 62, but output gear 60 may mesh with first stage 62 at any suitable position on first stage 62 for driving first stage 62. Load brake 68 is disposed between first stage 62 and second stage 64. An output of load brake 68 may be an input gear for second stage 64. Second stage 64 is preferably a first simple planetary gear set and third stage 66 is preferably a second simple planetary gear set. An output of third stage 66 is coupled to overload clutch 70. Traction clutch 72 is driven by a spur train off of cable drum 28. First output 74 is connected to and provides motive power to cable drum 28. Second output 76 extends from traction clutch 72 and drives traction sheave 24 (shown in FIG. 1).

Motor 40 provides motive power to drivetrain 42 through output gear 60 intermeshing with first stage 62. First stage 62 is connected to load brake 68, and load brake 68 is preferably a Weston-style load brake, which creates proportional clamping force across a disc pack the greater the tension on cable. As such, load brake 68 prevents slippage of the cable, and load brake 68 allows cable to be lowered through a series of controlled falls, which are perceived as a smooth lowering motion. Load brake 68 is connected to and drives lube pump 78, preferably through a simple spur stage. An output of load brake 68 is connected to second stage 64, and the output of load brake 68 may provide an input sun gear for second stage 64.

Each of second stage 64 and third stage 66 are preferably simple planetary gear sets. Second stage 64 and third stage 66 may have a common ring gear. An output of third stage 66 is directly coupled to overload clutch 70. Overload clutch 70 is a mechanical fuse that relieves a clamping force across the disc pack when a load on cable 46 reaches a set point, typically about twice the rated load of the hoist 10. In this way, overload clutch 70 is a safety mechanism that allows cable 46 to be pulled fully off of cable drum 28 if cable 46 is overloaded, thereby preventing damage to any machine, such as a helicopter, carrying translating body rescue hoist 10. First output 74 extends from drivetrain 42 and provides rotational power to cable drum 28. Second stage 64 and third stage 66 incorporate planetary gear stages using through-hardened gears, which reduces the overall cost of power train 42 by eliminating the need for high precision gearing and high precision bearing bores.

Traction clutch 72 is mounted to power train 42 and transmits torque outside of cable drum 28 to traction sheave 24 through traction shaft 50 such that traction sheave 24 provides a back tension on cable 46 regardless of whether cable 46 is being reeled in or reeled out. Alternatively, traction clutch 72 may be mounted outboard of cable drum 28 and housed within one of the supports, such as first end 34 (best seen in FIG. 2A) or second end 36 (best seen in FIG. 2A). Second output 76 extends from traction clutch 72 and connects traction sheave 24 and traction clutch 72.

Drivetrain 42 is housed within cable drum 28. Housing drivetrain 42 within cable drum 28 reduces the overall footprint of translating module 14 (shown in FIG. 2A), thereby allowing for the use of longer cable drums with increased cable drum diameters, thereby reducing the layers of cable disposed on the cable drum, which reduces the strain on the cable. In addition, the compact profile provided by mounting drivetrain 42 within cable drum 28 reduces the overall weight of translating body rescue hoist 10 because less structural elements are necessary to house all of the components of translating body rescue hoist 10. Drivetrain 42 preferably provides an overall reduction ratio of about 78:1, however, the reduction ratio of drivetrain 42 may be easily altered by adjusting the planetary ratios of the various stages.

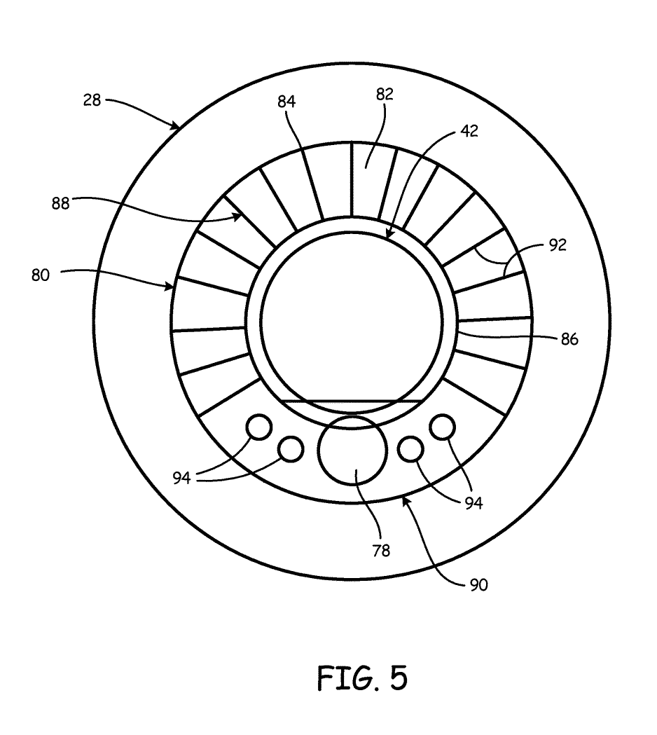

FIG. 5 is a partial, side cross-sectional view of cable drum 28 showing heat exchanger 80. Annulus 82 is disposed between inner diameter 84 of cable drum 28 and outer diameter 86 of drivetrain 42. Heat exchanger 80 includes air-air section 88 and air-oil section 90. Air-air section 88 includes cooling fins 92. Air-oil section 90 contains a lubricant and includes air tubes 94 and lube pump 78.

The lubricant is housed within air-oil section 90 separate from drivetrain 42. Lube pump 78 draws the lubricant from the air-oil section 90 and feeds the lubricant to drivetrain 42, where the lubricant is applied to drivetrain 42, preferably through an oil mist or in a direct stream. Applying the lubricant to drivetrain 42 through an oil mist or in a direct stream eliminates losses experienced due to paddle wheeling, which are experienced when a drivetrain is disposed directly in the lubricant. The lubricant is gravity scavenged back to air-oil section 90. Air tubes 94 pass through air-oil section 90, and cooling air passes through air tubes 94 to cool the lubricant. Air-air section 88 is separate from air-oil section 90, and cooling fins 92 are disposed within air-air section 88. Cooling fins 92 are air-air heat exchangers configured to cool annulus 82, thereby cooling drivetrain 42 and cable drum 28.

### Discussion of Possible Embodiments

The following are non-exclusive descriptions of possible embodiments of the present invention.

A hoist system includes a stationary frame, a cable guide array mounted to the stationary frame, a follower mounted to the stationary frame, a carrier mounted to the stationary frame, a cable drum mounted on the carrier, a level wind mechanism mounted on the carrier outward of the cable drum, a drivetrain mounted within the cable drum, the drivetrain configured to drive the cable drum and the level wind mechanism, a motor mounted on the carrier, the motor coupled to the drivetrain, and a bearing assembly disposed between and connecting the carrier and the stationary frame. A cable is wrapped around the cable drum and fed through the cable guide array, and the carrier is capable of reciprocating relative to the stationary frame.

The hoist system of the preceding paragraph can optionally include, additionally and/or alternatively, any one or more of the following features, configurations and/or additional components:

The follower engages the level wind mechanism

The drivetrain is configured to rotate the cable drum and the level wind mechanism

The level wind mechanism is a reversing screw.

The drivetrain includes a first stage coupled to and driven by the motor, a second stage driven by the first stage, and a third stage coupled to and driven by the second stage.

The second stage is a first planetary gear set and the third stage is a second planetary gear set.

The motor includes an output comprising a spur gear, the spur gear meshed with an internal gearing on the first stage ring gear.

A load brake disposed between the first stage and the second stage, and an overload clutch disposed between an output of the third stage and the cable drum, the overload clutch configured to unspool the cable in response to an overload of the cable.

The load brake drives a lube pump, the lube pump configured to provide a lubricant to the load brake and drivetrain.

The bearing assembly includes at least one linear bearing mounted on the stationary frame, and a guide rail mounted to the carrier and extending through the at least one linear bearing.

The frame includes a first arm extending from the frame and a second arm extending from the frame. The first arm includes a first linear bearing mounted within a first distal end of the first arm and the second arm includes a second linear bearing mounted within a second distal end of the second arm, the first linear bearing and the second linear bearing configured to receive the guide rail.

A traction sheave is disposed between the follower and the cable guide array, the cable passing through the traction sheave, wherein the traction sheave is configured to maintain a back tension on the cable as the cable passes from the cable drum to the cable guide array.

A method of hoisting includes feeding a cable around a cable drum and through a cable guide array, the cable guide array fixed to the stationary frame, engaging a follower with a level wind mechanism, and driving a cable drum and the level wind mechanism with a drive system at least partially mounted within the cable drum. The follower is interlocked with the level wind mechanism such that rotating the level wind mechanism drives a carriage in a reciprocating manner relative to the stationary frame.

The method of hoisting of the preceding paragraph can optionally include, additionally and/or alternatively, any one or more of the following features, configurations and/or additional components:

Mounting a drivetrain within the cable drum, mounting a motor on the carriage, and coupling the motor to the drivetrain, such that the motor powers the drivetrain.

Rotating the cable drum in a first direction with the drivetrain, wherein rotating the cable drum in the first direction causes the cable to unspool from the cable drum and pass through the follower and the cable guide array, and rotating the cable drum in a second direction with the drivetrain, wherein rotating the cable drum in the second direction causes the cable to pass through the cable guide array and the follower and re-spool on the cable drum.

Passing the cable through a traction sheave between the follower and the cable guide array, the traction sheave maintaining a tension of the cable inboard of the cable guide array.

A rescue hoist includes a stationary module fixed to a vehicle, a translating module, and a cable. The stationary module includes a frame, a cable guide array mounted to the frame, a follower mounted to the frame, and a traction sheave mounted to the frame. The translating module includes a carrier supported by the frame, the carrier configured to oscillate relative to the frame, a cable drum rotatably mounted to the carrier, a drive mounted to the carrier and at least partially disposed within the cable drum, and a level wind mechanism mounted to the carrier and intermeshed with the follower. The cable is disposed about the cable drum and extends through the traction sheave and the cable guide array. The translating module is configured to oscillate relative to the frame to unspool the cable from the cable drum or spool the cable on to the cable drum.

The rescue hoist of the preceding paragraph can optionally include, additionally and/or alternatively, any one or more of the following features, configurations and/or additional components:

The drive includes a drivetrain mounted within the cable drum and configured to drive the cable drum and the level wind mechanism, and a motor mounted to the carrier and connected to the drivetrain, the motor configured to drive the drivetrain.

A bearing assembly supporting the carrier on the frame.

A first arm extending from the frame, the first arm including a first clevis and a second clevis, a second arm extending from the frame, the second arm including a third clevis and a fourth clevis, wherein the first clevis, the second clevis, the third clevis, and the fourth clevis are configured to receive lugs extending from the aircraft to secure the rescue hoist to the aircraft.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A hoist system comprising:
a stationary frame;
a cable guide array mounted to the stationary frame;
a follower mounted to the stationary frame;
a carrier mounted to the stationary frame;
a cable drum mounted on the carrier;
a level wind mechanism mounted on the carrier outward of the cable drum;
a drivetrain mounted within the cable drum, the drivetrain configured to drive the cable drum and the level wind mechanism;
a motor mounted on the carrier, the motor coupled to the drivetrain; and
a bearing assembly disposed between and connecting the carrier and the stationary frame;
wherein a cable is wrapped around the cable drum and fed through the cable guide array; and
wherein the carrier is capable of reciprocating relative to the stationary frame.

2. The hoist system of claim 1, wherein the follower engages the level wind mechanism.

3. The hoist system of claim 1, wherein the drivetrain is configured to rotate the cable drum and the level wind mechanism.

4. The hoist system of claim 1, wherein the level wind mechanism comprises a reversing screw.

5. The hoist system of claim 1, wherein the drivetrain comprises:
a first stage coupled to and driven by the motor;
a second stage driven by the first stage; and
a third stage coupled to and driven by the second stage.

6. The hoist system of claim 5, wherein the second stage comprises a first planetary gear set and the third stage comprises a second planetary gear set.

7. The hoist system of claim 5, wherein the motor further comprises:
an output comprising a spur gear, the spur gear meshed with an internal gearing on a first stage ring gear.

8. The hoist system of claim 5, and further comprising:
a load brake disposed between the first stage and the second stage; and
an overload clutch disposed between an output of the third stage and the cable drum, the overload clutch configured to unspool the cable in response to an overload of the cable.

9. The hoist system of claim 8, wherein the load brake drives a lube pump, the lube pump configured to provide a lubricant to the load brake and drivetrain.

10. The hoist system of claim 1, wherein the bearing assembly comprises:
at least one linear bearing mounted on the stationary frame; and
a guide rail mounted to the carrier and extending through the at least one linear bearing.

11. The hoist system of claim 10, wherein the frame further comprises:
a first arm extending from the frame; and
a second arm extending from the frame;
wherein the first arm includes a first linear bearing mounted at a first distal end of the first arm and the second arm includes a second linear bearing mounted at a second distal end of the second arm, the first linear bearing and the second linear bearing are configured to receive the guide rail.

12. The hoist system of claim 1, and further comprising:
a traction sheave disposed between the cable drum and the cable guide array, the cable passing through the traction sheave, wherein the traction sheave is configured to maintain a back tension on the cable as the cable passes from the cable drum to the cable guide array.

13. A method of hoisting comprising:
feeding a cable around a cable drum and through a cable guide array, the cable guide array fixed to the stationary frame;
engaging a follower with a level wind mechanism; and
driving a cable drum and the level wind mechanism with a drive system at least partially mounted within the cable drum;
wherein the follower is interlocked with the level wind mechanism such that rotating the level wind mechanism drives a carriage in a reciprocating manner relative to the stationary frame.

14. The method of claim 13, and further comprising:
mounting a drivetrain within the cable drum;
mounting a motor on the carriage; and
coupling the motor to the drivetrain, such that the motor powers the drivetrain.

15. The method of claim 14, wherein the step of driving the cable drum and the level wind mechanism further comprises:
rotating the cable drum in a first direction with the drivetrain, wherein rotating the cable drum in the first direction causes the cable to unspool from the cable drum and pass through the follower and the cable guide array; and
rotating the cable drum in a second direction with the drivetrain, wherein rotating the cable drum in the second direction causes the cable to pass through the cable guide array and the follower and re-spool on the cable drum.

16. The method of claim 13, and further comprising:
passing the cable through a traction sheave before the cable guide array, the traction sheave maintaining a tension of the cable inboard of the cable guide array.

17. A rescue hoist comprising:
a stationary module fixed to a vehicle, the stationary module comprising:
a frame;
a cable guide array mounted to the frame;
a follower mounted to the frame; and
a traction sheave mounted to the frame;
a translating module comprising:
a carrier supported by the frame, the carrier configured to oscillate relative to the frame;
a cable drum rotatably mounted to the carrier;
a drive mounted to the carrier and at least partially disposed within the cable drum; and
a level wind mechanism mounted to the carrier and intermeshed with the follower; and
a cable disposed about the cable drum and extending through the traction sheave and the cable guide array;
wherein the translating module is configured to oscillate relative to the frame to unspool the cable from the cable drum or to spool the cable on to the cable drum.

18. The rescue hoist of claim 17, wherein the drive further comprises:
a drivetrain mounted within the cable drum and configured to drive the cable drum and the level wind mechanism; and
a motor mounted to the carrier and connected to the drivetrain, the motor configured to drive the drivetrain.

19. The rescue hoist of claim 17, and further comprising a bearing assembly supporting the carrier on the frame.

20. The rescue hoist of claim 17, wherein the frame further comprises:
a first arm extending from the frame, the first arm including a first clevis and a second clevis;
a second arm extending from the frame, the second arm including a third clevis and a fourth clevis;
wherein the first clevis, the second clevis, the third clevis, and the fourth clevis are configured to receive lugs extending from the vehicle to secure the rescue hoist to the vehicle.
